(19) United States
(12) Patent Application Publication
(10) Pub. No.: US 2006/0221071 A1
(43) Pub. Date: Oct. 5, 2006

(54) Horizontal perspective display

(76) Inventors: Michael A. Vesely, Santa Cruz, CA (US); Nancy L. Clemens, Santa Cruz, CA (US)

Correspondence Address: Tue Nguyen, 496 Olive Ave., Fremont, CA, 94539, US

(21) Appl. No.: 11/429,830

(22) Filed: May 8, 2006

Related U.S. Application Data
(63) Continuation-in-part of application No. 11/098,681, filed on Apr. 4, 2005.
(60) Provisional application No. 60/679,632, filed on May 9, 2005.

(51) Int. Cl. G06T 15/00

(52) U.S. Cl. 345/419

(57) ABSTRACT

The personal computer is perfectly suitable for horizontal perspective display, designed for the operation of one person, and well capable of rendering various horizontal perspective images to the viewer. Thus the present invention discloses a real time electronic display that can adjust the horizontal perspective images to accommodate the position of the viewer. By changing the displayed images to keep the eyepoint point of the horizontal perspective image in the same position as the viewer's eye point, the viewer's eye is always positioned at the proper viewing position to perceive the three dimensional illusion, thus minimizing viewer's discomfort and distortion. The display can accept manual input such as a computer mouse, trackball, joystick, tablet, etc. to re-position the horizontal perspective images. The display can also automatically re-position the images based on an input device automatically providing the viewer's viewpoint location.

This application claims priority from U.S. provisional applications Ser. No. 60/679,632, filed May 9, 2005, entitled “Horizontal perspective display”, which is incorporated herein by reference. This application is a continuation-in-part of pending applications Ser. No. 11/098,681, filed Apr. 4, 2005, entitled “Horizontal perspective display”, and Ser. No. 11/098,685, filed Apr. 4, 2005, entitled “Horizontal perspective display”, hereby incorporated by reference.

### FIELD OF INVENTION

This invention relates to a three-dimensional display system, and in particular, to a display system capable of adjusting the displayed images to accommodate the viewer's vision.

### BACKGROUND OF THE INVENTION

Ever since humans began to communicate through pictures, they faced a dilemma of how to accurately represent the three-dimensional world they lived in. Sculpture was used to successfully depict three-dimensional objects, but was not adequate to communicate spatial relationships between objects and within environments. To do this, early humans attempted to “flatten” what they saw around them onto two-dimensional, vertical planes (e.g. paintings, drawings, tapestries, etc.). Scenes where a person stood upright, surrounded by trees, were rendered relatively successfully on a vertical plane. But how could they represent a landscape, where the ground extended out horizontally from where the artist was standing, as far as the eye could see?

The answer is three dimensional illusions. The two dimensional pictures must provide a numbers of cues of the third dimension to the brain to create the illusion of three dimensional images. This effect of third dimension cues can be realistically achievable due to the fact that the brain is quite accustomed to it. The three dimensional real world is always and already converted into two dimensional (e.g. height and width) projected image at the retina, a concave surface at the back of the eye. And from this two dimensional image, the brain, through experience and perception, generates the depth information to form the three dimension visual image from two types of depth cues: monocular (one eye perception) and binocular (two eye perception). In general, binocular depth cues are innate and biological while monocular depth cues are learned and environmental.

The major binocular depth cues are convergence and retinal disparity. The brain measures the amount of convergence of the eyes to provide a rough estimate of the distance since the angle between the line of sight of each eye is larger when an object is closer. The disparity of the retinal images due to the separation of the two eyes is used to create the perception of depth. The effect is called stereoscopy where each eye receives a slightly different view of a scene, and the brain fuses them together using these differences to determine the ratio of distances between nearby objects.

Binocular cues are very powerful perception of depth. However, there are also depth cues with only one eye, called monocular depth cues, to create an impression of depth on a flat image. The major monocular cues are: overlapping, relative size, linear perspective and light and shadow. When an object is viewed partially covered, this pattern of blocking is used as a cue to determine that the object is farther away. When two objects known to be the same size and one appears smaller than the other, this pattern of relative size is used as a cue to assume that the smaller object is farther away. The cue of relative size also provides the basis for the cue of linear perspective where the farther away the lines are from the observer, the closer together they will appear since parallel lines in a perspective image appear to converge towards a single point. The light falling on an object from a certain angle could provide the cue for the form and depth of an object. The distribution of light and shadow on an object is a powerful monocular cue for depth provided by the biologically correct assumption that light comes from above.

Perspective drawing, together with relative size, is most often used to achieve the illusion of three dimension depth and spatial relationships on a flat (two dimensions) surface, such as paper or canvas. Through perspective, three dimension objects are depicted on a two dimension plane, but “trick” the eye into appearing to be in three dimension space. The first theoretical treatise for constructing perspective, Depictura, was published in the early 1400's by the architect, Leone Battista Alberti. Since the introduction of his book, the details behind “general” perspective have been very well documented. However, the fact that there are a number of other types of perspectives is not well known. Some examples are military 1, cavalier 2, isometric 3, dimetric 4, central perspective 5 and two-point perspective 6 as shown in FIG. 1.

Of special interest is the most common type of perspective, called central perspective 5, shown at the bottom left of FIG. 1. Central perspective, also called one-point perspective, is the simplest kind of “genuine” perspective construction, and is often taught in art and drafting classes for beginners. FIG. 2 further illustrates central perspective. Using central perspective, the chess board and chess pieces look like three dimension objects, even though they are drawn on a two dimensional flat piece of paper. Central perspective has a central vanishing point 21, and rectangular objects are placed so their front sides are parallel to the picture plane. The depth of the objects is perpendicular to the picture plane. All parallel receding edges run towards a central vanishing point. The viewer looks towards this vanishing point with a straight view. When an architect or artist creates a drawing using central perspective, they must use a single-eye view. That is, the artist creating the drawing captures the image by looking through only one eye, which is perpendicular to the drawing surface.

The vast majority of images, including central perspective images, are displayed, viewed and captured in a plane perpendicular to the line of vision. Viewing the images at angle different from 90° would result in image distortion, meaning a square would be seen as a rectangle when the viewing surface is not perpendicular to the line of vision. However, there is a little known class of images that we called it “horizontal perspective” where the image appears distorted when viewing head on, but displaying a three dimensional illusion when viewing from the correct viewing position. In horizontal perspective, the angle between the viewing surface and the line of vision is preferably 45° but can be almost any angle, and the viewing surface is preferably horizontal (wherein the name “horizontal perspective”), but it can be any surface, as long as the line of vision forming a not-perpendicular angle to it.

Horizontal perspective images offer realistic three dimensional illusion, but are little known primarily due to the narrow viewing location (the viewer's eyepoint has to be coincide precisely with the image projection eyepoint), and the complexity involving in projecting the two dimensional image or the three dimension model into the horizontal perspective image.

The generation of horizontal perspective images requires considerably more expertise to create than conventional perpendicular images. The conventional perpendicular images can be produced directly from the viewer or camera point. One need simply open one's eyes or point the camera in any direction to obtain the images. Further, with much experience in viewing three dimensional depth cues from perpendicular images, viewers can tolerate significant amount of distortion generated by the deviations from the camera point. In contrast, the creation of a horizontal perspective image does require much manipulation. Conventional camera, by projecting the image into the plane perpendicular to the line of sight, would not produce a horizontal perspective image. Making a horizontal drawing requires much effort and very time consuming. Further, since human has limited experience with horizontal perspective images, the viewer's eye must be positioned precisely where the projection eyepoint point is to avoid image distortion. And therefore horizontal perspective, with its difficulties, has received little attention.

### SUMMARY OF THE INVENTION

The present invention recognizes that the personal computer is perfectly suitable for horizontal perspective display. It is personal, thus it is designed for the operation of one person, and the computer, with its powerful microprocessor, is well capable of rendering various horizontal perspective images to the viewer.

Thus the present invention discloses a real time electronic display that can adjust the horizontal perspective images to accommodate the position of the viewer. By changing the displayed images to keep the eyepoint of the horizontal perspective image in the same position as the viewer's eyepoint, the viewer's eye is always positioned at the proper viewing position to perceive the three dimensional illusion, thus minimizing viewer's discomfort and distortion. The display can accept manual input such as a computer mouse, trackball, joystick, tablet, etc. to re-position the horizontal perspective images. The display can also automatically re-position the images based on an input device automatically providing the viewer's eyepoint location.

Further, the display is not limited to project two dimensional images but also three dimensional models. Multiple inputs would also be included, one to keep the image in proper perspective, and one to manipulate the images such as rotation, movement or amplification.

The horizontal perspective display can be adjusted in different ways when the viewer's eyepoint moves. The most preferred method is that the viewer angle also changes so that the viewer can see a different section of the image. This method is easily accomplished when the image is a three dimensional model, so that when the viewer moves, for example, toward the back of the image, the display is shifted to re-display the back side. If the image is only a two-dimensional image, the simple way is to just re-display the same image with a different eyepoint, meaning the viewer turning to the back would still see the same image. Another way is to provide some simulation to simulate a three-dimensional image with a two-dimensional one. Thus the two-dimensional image becomes a pseudo three-dimensional image, and thus when the viewer moves, the image is shifted to display a different view of the image.

### BRIEF DESCRIPTION OF THE DRAWINGS

FIG. 1 shows the various perspective drawings.

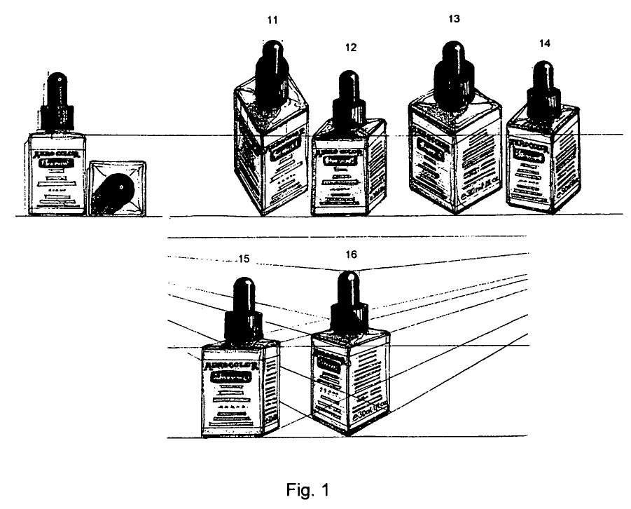

FIG. 2 shows a typical central perspective drawing.

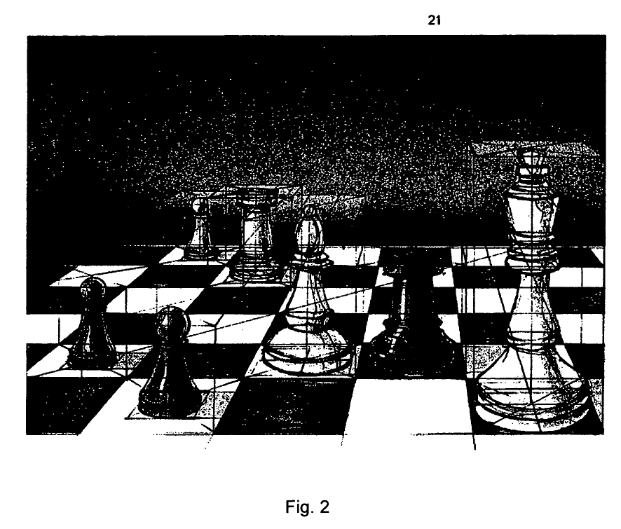

FIG. 3 shows the comparison of central perspective (Image A) and horizontal perspective (Image B).

FIG. 4 shows the central perspective drawing of three stacking blocks.

FIG. 5 shows the horizontal perspective drawing of three stacking blocks.

FIG. 6 shows the method of drawing a horizontal perspective drawing.

FIG. 7 shows an embodiment of the present invention, including a horizontal perspective display and a viewer input device.

FIG. 8 shows another embodiment of the present invention, including a horizontal perspective display, a computational device and a viewer input device.

FIG. 9 shows mapping of the 3-d object onto the horizontal plane.

FIG. 10 shows the projection of 3-d object by horizontal perspective.

FIG. 11 shows the simulation time of the horizontal perspective.

### DETAILED DESCRIPTION OF THE INVENTION

The present invention discloses a horizontal perspective display system capable of projecting three dimensional illusions based on horizontal perspective projection.

Horizontal perspective is a little-known perspective, of which we found only two books that describe its mechanics: Stereoscopic Drawing© (1990) and How to Make Anaglyphs© (1979, out of print). Although these books describe this obscure perspective, they do not agree on its name. The first book refers to it as a “free-standing anaglyph,” and the second, a “phantogram.” Another publication called it “projective anaglyph” (U.S. Pat. No. 5,795,154 by G. M. Woods, Aug. 18, 1998). Since there is no agreed-upon name, we have taken the liberty of calling it “horizontal perspective.” Normally, as in central perspective, the plane of vision, at right angle to the line of sight, is also the projected plane of the picture, and depth cues are used to give the illusion of depth to this flat image. In horizontal perspective, the plane of vision remains the same, but the projected image is not on this plane. It is on a plane angled to the plane of vision. Typically, the image would be on the ground level surface. This means the image will be physically in the third dimension relative to the plane of vision. Thus horizontal perspective can be called horizontal projection.

In horizontal perspective, the object is to separate the image from the paper, and fuse the image to the three dimension object that projects the horizontal perspective image. Thus the horizontal perspective image must be distorted so that the visual image fuses to form the free standing three dimensional figure. It is also essential the image is viewed from the correct eye points, otherwise the three dimensional illusion is lost. In contrast to central perspective images which have height and width, and project an illusion of depth, and therefore the objects are usually abruptly projected and the images appear to be in layers, the horizontal perspective images have actual depth and width, and illusion gives them height, and therefore there is usually a graduated shifting so the images appear to be continuous.

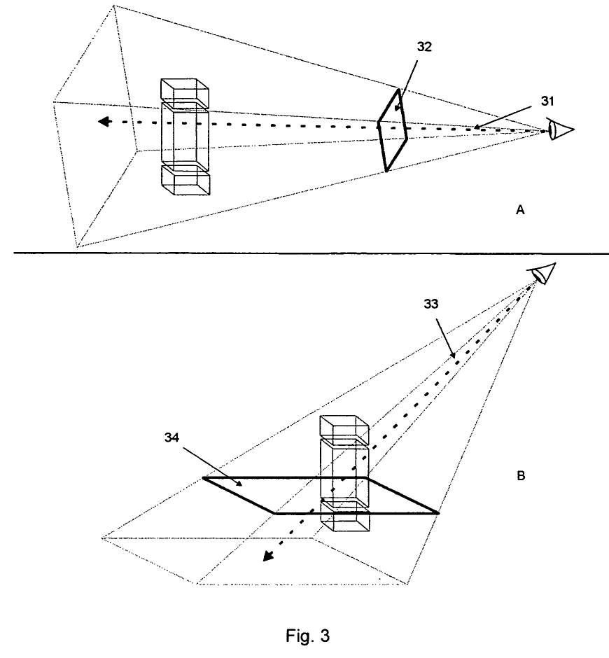

FIG. 3 compares key characteristics that differentiate central perspective and horizontal perspective. Image A shows key pertinent characteristics of central perspective, and Image B shows key pertinent characteristics of horizontal perspective.

In other words, in Image A, the real-life three dimension object (three blocks stacked slightly above each other) was drawn by the artist closing one eye, and viewing along a line of sight 31 perpendicular to the vertical drawing plane 32. The resulting image, when viewed vertically, straight on, and through one eye, looks the same as the original image.

In Image B, the real-life three dimension object was drawn by the artist closing one eye, and viewing along a line of sight 33 45° to the horizontal drawing plane 34. The resulting image, when viewed horizontally, at 45° and through one eye, looks the same as the original image.

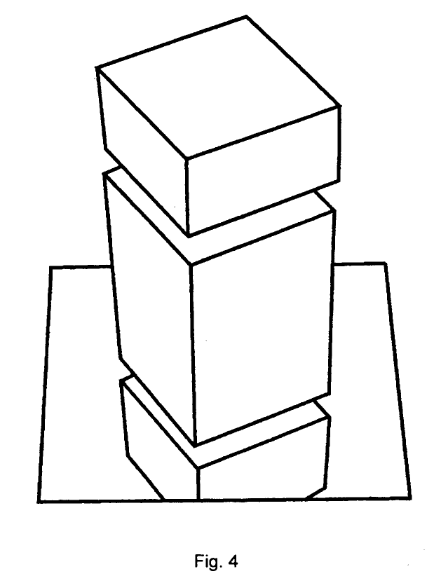

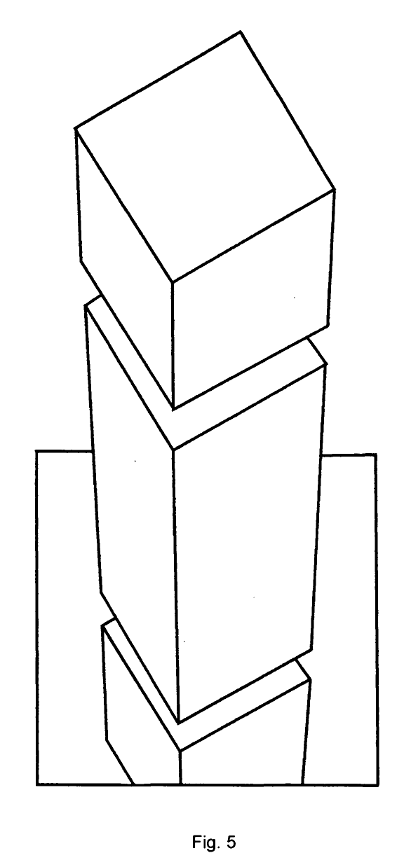

FIGS. 4 and 5 illustrate the visual difference between using central and horizontal perspective. To experience this visual difference, first look at FIG. 4, drawn with central perspective, through one open eye. Hold the piece of paper vertically in front of you, as you would a traditional drawing, perpendicular to your eye. You can see that central perspective provides a good representation of three dimension objects on a two dimension surface.

Now look at FIG. 5, drawn using horizontal perspective, by sifting at your desk and placing the paper lying flat (horizontally) on the desk in front of you. Again, view the image through only one eye. This puts your one open eye, called the eye point at approximately a 45° angle to the paper, which is the angle that the artist used to make the drawing. To get your open eye and its line-of-sight to coincide with the artist's, move your eye downward and forward closer to the drawing, about six inches out and down and at a 45° angle. This will result in the ideal viewing experience where the top and middle blocks will appear above the paper in open space.

Again, the reason your one open eye needs to be at this precise location is because both central and horizontal perspective not only define the angle of the line of sight from the eye point; they also define the distance from the eye point to the drawing. This means that FIGS. 4 and 5 are drawn with an ideal location and direction for your open eye relative to the drawing surfaces. However, unlike central perspective where deviations from position and direction of the eye point create little distortion, when viewing a horizontal perspective drawing, the use of only one eye and the position and direction of that eye relative to the viewing surface are essential to seeing the open space three dimension horizontal perspective illusion.

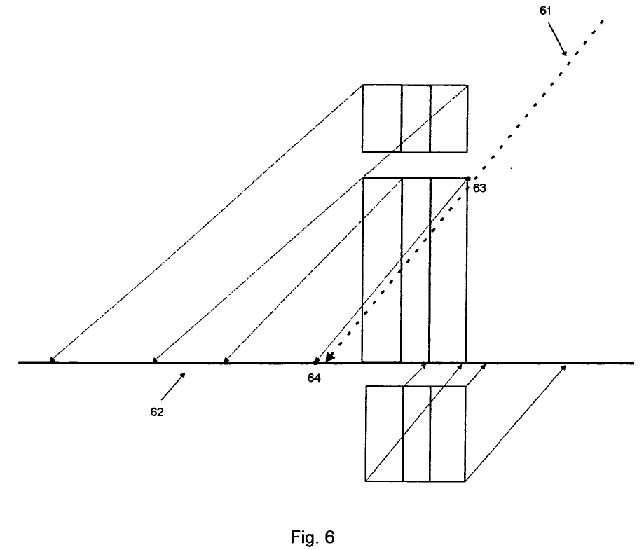

FIG. 6 is an architectural-style illustration that demonstrates a method for making simple geometric drawings on paper or canvas utilizing horizontal perspective. FIG. 6 is a side view of the same three blocks used in FIG. 5. It illustrates the actual mechanics of horizontal perspective. Each point that makes up the object is drawn by projecting the point onto the horizontal drawing plane. To illustrate this, FIG. 6 shows a few of the coordinates of the blocks being drawn on the horizontal drawing plane through projection lines. These projection lines start at the eye point (not shown in FIG. 6 due to scale), intersect a point 63 on the object, then continue in a straight line to where they intersect the horizontal drawing plane 62, which is where they are physically drawn as a single dot 64 on the paper. When an architect repeats this process for each and every point on the blocks, as seen from the drawing surface to the eye point along the 45° line-of-sight 61, the horizontal perspective drawing is complete, and looks like FIG. 5.

Notice that in FIG. 6, one of the three blocks appears below the horizontal drawing plane. With horizontal perspective, points located below the drawing surface are also drawn onto the horizontal drawing plane, as seen from the eye point along the line-of-site. Therefore when the final drawing is viewed, objects not only appear above the horizontal drawing plane, but may also appear below it as well—giving the appearance that they are receding into the paper. If you look again at FIG. 5, you will notice that the bottom box appears to be below, or go into, the paper, while the other two boxes appear above the paper in open space.

The generation of horizontal perspective images requires considerably more expertise to create than central perspective images. Even though both methods seek to provide the viewer the three dimension illusion that resulted from the two dimensional image, central perspective images produce directly the three dimensional landscape from the viewer or camera point. In contrast, the horizontal perspective image appears distorted when viewing head on, but this distortion has to be precisely rendered so that when viewing at a precise location, the horizontal perspective produces a three dimensional illusion.

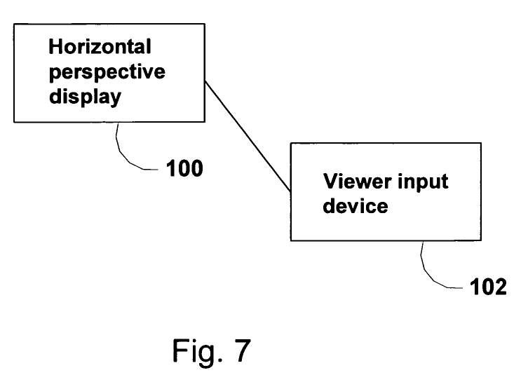

The present invention horizontal perspective display system promotes horizontal perspective projection viewing by providing the viewer with the means to adjust the displayed images to maximize the illusion viewing experience. By employing the computation power of the microprocessor and a real time display, the horizontal perspective display of the present invention is shown in FIG. 7, comprising a real time electronic display 100 capable of re-drawing the projected image, together with a viewer's input device 102 to adjust the horizontal perspective image. By re-display the horizontal perspective image so that its projection eyepoint coincides with the eyepoint of the viewer, the horizontal perspective display of the present invention can ensure the minimum distortion in rendering the three dimension illusion from the horizontal perspective method. The input device can be manually operated where the viewer manually inputs his or her eyepoint location, or change the projection image eyepoint to obtain the optimum three dimensional illusion. The input device can also be automatically operated where the display automatically tracks the viewer's eyepoint and adjust the projection image accordingly. The present invention removes the constraint that the viewers keeping their heads in relatively fixed positions, a constraint that create much difficulty in the acceptance of precise eyepoint location such as horizontal perspective or hologram display.

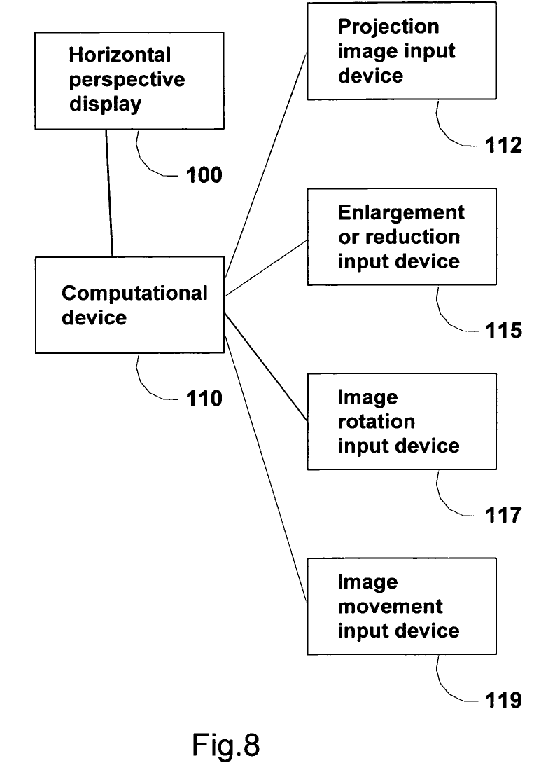

The horizontal perspective display system, shown in FIG. 8, can further a computation device 110 in addition to the real time electronic display device 100 and projection image input device 112 providing input to the computational device 110 to calculating the projectional images for display to providing a realistic, minimum distortion three dimensional illusion to the viewer by coincide the viewer's eyepoint with the projection image eyepoint. The system can further comprise an image enlargement/reduction input device 115, or an image rotation input device 117, or an image movement device 119 to allow the viewer to adjust the view of the projection images.

The input device can be operated manually or automatically. The input device can detect the position and orientation of the viewer eyepoint, to compute and to project the image onto the display according to the detection result. Alternatively, the input device can be made to detect the position and orientation of the viewer's head along with the orientation of the eyeballs. The input device can comprise an infrared detection system to detect the position the viewer's head to allow the viewer freedom of head movement. Other embodiments of the input device can be the triangulation method of detecting the viewer eyepoint location, such as a CCD camera providing position data suitable for the head tracking objectives of the invention. The input device can be manually operated by the viewer, such as a keyboard, mouse, trackball, joystick, or the like, to indicate the correct display of the horizontal perspective display images.

The disclosed invention comprises a number of new computer hardware and software elements and processes, and together with existing components creates a horizontal perspective viewing simulator. For the viewer to experience these unique viewing simulations the computer hardware viewing surface is preferably situated horizontally, such that the viewer's line of sight is at a 45° angle to the surface. Typically, this means that the viewer is standing or seated vertically, and the viewing surface is horizontal to the ground. Note that although the viewer can experience hands-on simulations at viewing angles other than 45° (e.g. 55°, 30° etc.), it is the optimal angle for the brain to recognize the maximum amount of spatial information in an open space image. Therefore, for simplicity's sake, we use “45°” throughout this document to mean “an approximate 45 degree angle”. Further, while horizontal viewing surface is preferred since it simulates viewers' experience with the horizontal ground, any viewing surface could offer similar three dimensional illusion experience. The horizontal perspective illusion can appear to be hanging from a ceiling by projecting the horizontal perspective images onto a ceiling surface, or appear to be floating from a wall by projecting the horizontal perspective images onto a vertical wall surface.

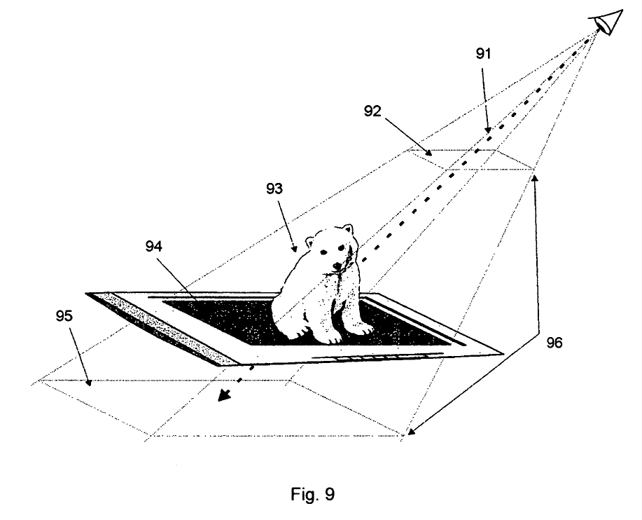

The viewing simulations are generated within a three dimensional graphics view volume, both situated above and below the physical viewing surface. Mathematically, the computer-generated x, y, z coordinates of the Angled Camera point form the vertex of an infinite “pyramid”, whose sides pass through the x, y, z coordinates of the Reference/Horizontal Plane. FIG. 9 illustrates this infinite pyramid, which begins at the Angled Camera point and extending through the Far Clip Plane 95. The viewing volume 96 is defined by a Comfort Plane 92, a plane on top of the viewing volume 96, and is appropriately named because its location within the pyramid determines the viewer's personal comfort, i.e. how their eyes, head, body, etc. are situated while viewing and interacting with simulations. The 3D object 93 is horizontal perspectively projected from the horizontal plane 94.

For the viewer to view open space images on their physical viewing device it must be positioned properly, which usually means the physical Reference Plane is placed horizontally to the ground. Whatever the viewing device's position relative to the ground, the Reference/Horizontal Plane must be at approximately a 45° angle to the viewer's line-of-site 91 for optimum viewing.

One way the viewer might perform this step is to position their CRT computer monitor on the floor in a stand, so that the Reference/Horizontal Plane is horizontal to the floor. This example uses a CRT-type television or computer monitor, but it could be any type of viewing device, display screen, monochromic or color display, luminescent, TFT, phosphorescent, computer projectors and other method of image generation in general, providing a viewing surface at approximately a 45° angle to the viewer's line-of-sight.

The display needs to know the view's eyepoint to proper display the horizontal perspective images. One way to do this is for the viewer to supply the horizontal perspective display with their eye's real-world x, y, z location and line-of-site information relative to the center of the physical Reference/Horizontal Plane. For example, the viewer tells the horizontal perspective display that their physical eye will be located 12 inches up, and 12 inches back, while looking at the center of the Reference/Horizontal Plane. The horizontal perspective display then maps the computer-generated Angled Camera point to the viewer's eyepoint physical coordinates and line-of-site. Another way is for the viewer to manually adjusting an input device such as a mouse, and the horizontal perspective display adjust its image projection eyepoint until the proper eyepoint location is experienced by the viewer. Another way is using triangulation with infrared device or camera to automatically locate the viewer's eyes locations.

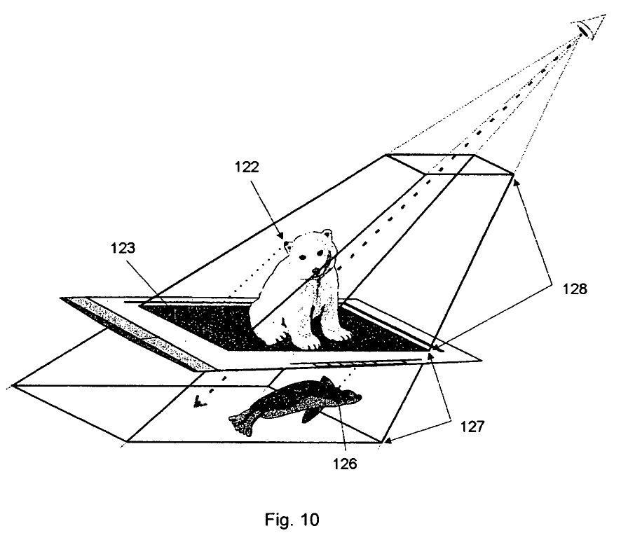

FIG. 10 is an illustration of the horizontal perspective display that includes all of the new computer-generated and real physical elements as described in the steps above. It also shows that a real-world element and its computer-generated equivalent are mapped 1:1 and together share a common Reference Plane 123. The full implementation of this horizontal perspective display results in a real-time computer-generated three dimensional graphics 122 appearing in open space on and above a viewing device's surface in the hands-on volume 128, and a three dimensional graphics 126 appearing under the viewing device's surface in the inner-access volume 127, which are oriented approximately 45° to the viewer's line-of-sight.

The present invention also allows the viewer to move around the three dimensional display and yet suffer no great distortion since the display can track the viewer eyepoint and re-display the images correspondingly, in contrast to the conventional prior art three dimensional image display where it would be projected and computed as seen from a singular viewing point, and thus any movement by the viewer away from the intended viewing point in space would cause gross distortion.

The display system can further comprise a computer capable of re-calculate the projected image given the movement of the eyepoint location. The horizontal perspective images can be very complex, tedious to create, or created in ways that are not natural for artists or cameras, and therefore require the use of a computer system for the tasks. To display a three-dimensional image of an object with complex surfaces or to create an animation sequences would demand a lot of computational power and time, and therefore it is a task well suited to the computer. Three dimensional capable electronics and computing hardware devices and real-time computer-generated three dimensional computer graphics have advanced significantly recently with marked innovations in visual, audio and tactile systems, and have producing excellent hardware and software products to generate realism and more natural computer-human interfaces.

The horizontal perspective display system of the present invention are not only in demand for entertainment media such as televisions, movies, and video games but are also needed from various fields such as education (displaying three-dimensional structures), technological training (displaying three-dimensional equipment). There is an increasing demand for three-dimensional image displays, which can be viewed from various angles to enable observation of real objects using object-like images. The horizontal perspective display system is also capable of substitute a computer-generated reality for the viewer observation. The systems may include audio, visual, motion and inputs from the user in order to create a complete experience of three dimensional illusion.

The input for the horizontal perspective system can be two dimensional image, several images combined to form one single three dimensional image, or three dimensional model. The three dimensional image or model conveys much more information than that a two dimensional image and by changing viewing angle, the viewer will get the impression of seeing the same object from different perspectives continuously.

In the present invention, the eyepoint of the horizontal perspective display is re-adjusted to be at the same location as the viewer's eyepoint, so that the there dimensional illusion is at its best. When the viewer moves, the viewer's eyepoint changes and thus the eyepoint of the horizontal perspective display also changes to match with the viewer's eyepoint. Even though the display changes (because the eyepoint changes), the display information could be the same or could be different. For example, if an image is displayed through horizontal perspective by a strictly two dimensional picture, no matter how the viewer changes the viewing position, the viewer still sees the same displayed image. If the image of the front of a house is displayed, even when the viewer moves to the back of the image, the image is re-displayed to match the viewer's eyepoint, but still shows the front side of the house. On the other hand, if the image is from a three dimensional model, when the viewer moves to the back of the house, the image is re-displayed to match the viewer's eyepoint, but the displayed image now shows the back of the house. In a pseudo three dimensional image, meaning image taken from a two dimensional picture but simulated to achieve three dimensional aspect, the two-dimensional image can behave like a three dimensional model, i.e. different view of the image is displayed when the viewer moves to different positions.

This different viewing angle can be achieved easily through automatic viewer's eyepoint tracking. In the event of manual eyepoint tracking, the viewer would have to enter a new eyepoint coordinates after moving.

The horizontal perspective display can further provide multiple views or “Multi-flew” capability. Multi-View provides the viewer with multiple and/or separate left- and right-eye views of the same simulation. Multi-View capability is a significant visual and interactive improvement over the single eye view. In Multi-View mode, both the left eye and right eye images are fused by the viewer's brain into a single, three-dimensional illusion. The problem of the discrepancy between accommodation and convergence of eyes, inherent in stereoscopic images, leading to the viewer's eye fatigue with large discrepancy, can be reduced with the horizontal perspective display, especially for motion images, since the position of the viewer's gaze point changes when the display scene changes.

In Multi-View mode, the objective is to simulate the actions of the two eyes to create the perception of depth, namely the left eye and the right eye sees slightly different images. Thus Multi-View devices that can be used in the present invention include methods with glasses such as anaglyph method, special polarized glasses or shutter glasses, methods without using glasses such as a parallax stereogram, a lenticular method, and mirror method (concave and convex lens).

In anaglyph method, a display image for the right eye and a display image for the left eye are respectively superimpose-displayed in two colors, e.g., red and blue, and observation images for the right and left eyes are separated using color filters, thus allowing a viewer to recognize a stereoscopic image. The images are displayed using horizontal perspective technique with the viewer looking down at an angle. As with one eye horizontal perspective method, the eyepoint of the projected images has to be coincide with the eyepoint of the viewer, and therefore the viewer input device is essential in allowing the viewer to observe the three dimensional horizontal perspective illusion. From the early days of the anaglyph method, there are many improvements such as the spectrum of the red/blue glasses and display to generate much more realism and comfort to the viewers.

In polarized glasses method, the left eye image and the right eye image are separated by the use of mutually extinguishing polarizing filters such as orthogonally linear polarizer, circular polarizer, and elliptical polarizer. The images are normally projected onto screens with polarizing filters and the viewer is then provided with corresponding polarized glasses. The left and right eye images appear on the screen at the same time, but only the left eye polarized light is transmitted through the left eye lens of the eyeglasses and only the right eye polarized light is transmitted through the right eye lens.

Another way for stereoscopic display is the image sequential system. In such a system, the images are displayed sequentially between left eye and right eye images rather than superimposing them upon one another, and the viewer's lenses are synchronized with the screen display to allow the left eye to see only when the left image is displayed, and the right eye to see only when the right image is displayed. The shuttering of the glasses can be achieved by mechanical shuttering or with liquid crystal electronic shuttering. In shuttering glass method, display images for the right and left eyes are alternately displayed on a CRT in a time sharing manner, and observation images for the right and left eyes are separated using time sharing shutter glasses which are opened/closed in a time sharing manner in synchronism with the display images, thus allowing an observer to recognize a stereoscopic image.

Other way to display stereoscopic images is by optical method. In this method, display images for the right and left eyes, which are separately displayed on a viewer using optical means such as prisms, mirror, lens, and the like, are superimpose-displayed as observation images in front of an observer, thus allowing the observer to recognize a stereoscopic image. Large convex or concave lenses can also be used where two image projectors, projecting left eye and right eye images, are providing focus to the viewer's left and right eye respectively. A variation of the optical method is the lenticular method where the images form on cylindrical lens elements or two dimensional array of lens elements.

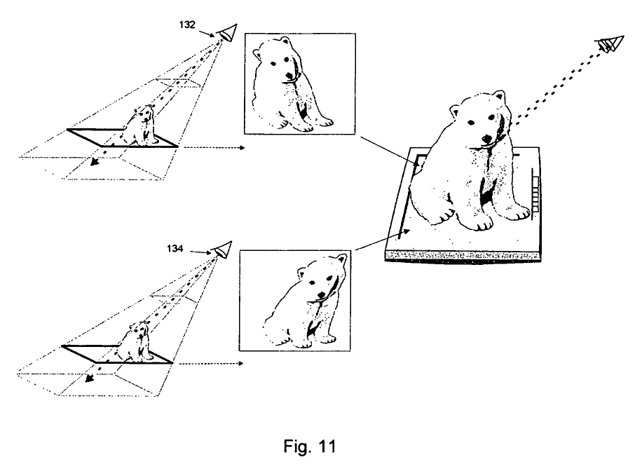

FIG. 11 is a horizontal perspective display focusing on how the computer-generated person's two eye views are projected onto the Horizontal Plane and then displayed on a stereoscopic 3D capable viewing device. FIG. 11 represents one complete display time period. During this display time period, the horizontal perspective display needs to generate two different eye views, because in this example the stereoscopic 3D viewing device requires a separate left- and right-eye view. There are existing stereoscopic 3D viewing devices that require more than a separate left- and right-eye view, and because the method described here can generate multiple views it works for these devices as well.

The illustration in the upper left of FIG. 11 shows the Angled Camera point for the right eye 132 after the first (right) eye-view to be generated. Once the first (right) eye view is complete, the horizontal perspective display starts the process of rendering the computer-generated person's second eye (left-eye) view. The illustration in the lower left of FIG. 11 shows the Angled Camera point for the left eye 134 after the completion of this time. But before the rendering process can begin, the horizontal perspective display makes an adjustment to the Angled Camera point. This is illustrated in FIG. 11 by the left eye's x coordinate being incremented by two inches. This difference between the right eye's x value and the left eye's x+2″ is what provides the two-inch separation between the eyes, which is required for stereoscopic 3D viewing. The distances between people's eyes vary but in the above example we are using the average of 2 inches. It is also possible for the view to supply the horizontal perspective display with their personal eye separation value. This would make the x value for the left and right eyes highly accurate for a given viewer and thereby improve the quality of their stereoscopic 3D view.

Once the horizontal perspective display has incremented the Angled Camera point's x coordinate by two inches, or by the personal eye separation value supplied by the viewer, the rendering continues by displaying the second (left-eye) view.

Depending on the stereoscopic 3D viewing device used, the horizontal perspective display continues to display the left- and right-eye images, as described above, until it needs to move to the next display time period. An example of when this may occur is if the bear cub moves his paw or any part of his body. Then a new and second Simulated Image would be required to show the bear cub in its new position. This new Simulated Image of the bear cub, in a slightly different location, gets rendered during a new display time period. This process of generating multiple views via the nonstop incrementing of display time continues as long as the horizontal perspective display is generating real-time simulations in stereoscopic 3D.

By rapidly display the horizontal perspective images, three dimensional illusion of motion can be realized. Typically, 30 to 60 images per second would be adequate for the eye to perceive motion. For stereoscopy, the same display rate is needed for superimposed images, and twice that amount would be needed for time sequential method.

The display rate is the number of images per second that the display uses to completely generate and display one image. This is similar to a movie projector where 24 times a second it displays an image. Therefore, 1/24 of a second is required for one image to be displayed by the projector. But the display time could be a variable, meaning that depending on the complexity of the view volumes it could take 1/12 or ½ a second for the computer to complete just one display image. Since the display was generating a separate left and right eye view of the same image, the total display time is twice the display time for one eye image.

What is claimed is:

1. A method of real time three dimensional image display by horizontal perspective projection, the horizontal perspective projection comprising a display of horizontal perspective images according to a predetermined projection eyepoint, the method comprising the steps of:
detecting an eyepoint movement of a viewer;
getting a new eyepoint location of the viewer with respect to the old eyepoint location corresponding to the eyepoint movement; and
displaying a horizontal perspective image using the new eyepoint location as the projection eyepoint,
wherein the horizontal perspective image shows a different view corresponding to the eyepoint movement of the viewer.

2. A method as in claim 1 wherein detecting a viewer eyepoint location is by manually inputting the location through a manual input device.

3. A method as in claim 1 wherein the detection of a viewer eyepoint location is through an automatic input device whereby the automatic input device automatically extracts the eyepoint location from the viewer.

4. A method as in claim 1 further comprising the step of manipulating the image.

5. A method of real time three dimensional image display by horizontal perspective projection, the horizontal perspective projection comprising a display of horizontal perspective images according to a predetermined projection eyepoint, the method comprising the steps of:
detecting an eyepoint movement of a viewer;
getting a new eyepoint location of the viewer with respect to the old eyepoint location corresponding to the eyepoint movement;
calculating a horizontal perspective image using the new eyepoint location as the projection eyepoint; and
displaying the horizontal perspective image,
wherein the horizontal perspective image shows a different view corresponding to the eyepoint movement of the viewer.

6. A method as in claim 5 wherein detecting a viewer eyepoint location is by manually inputting the location through a manual input device.

7. A method as in claim 5 wherein the detection of a viewer eyepoint location is through an automatic input device whereby the automatic input device automatically extracts the eyepoint location from the viewer.

8. A method as in claim 5 further comprising the step of manipulating the image.

9. A method of real time three dimensional image display by horizontal perspective projection, the horizontal perspective projection comprising a display of horizontal perspective images according to a predetermined projection eyepoint, the method comprising the steps of:
continuously scanning to detect an eyepoint movement of a viewer;
getting a new eyepoint location of the viewer with respect to the old eyepoint location corresponding to the eyepoint movement;
calculating a new horizontal perspective image using the new eyepoint location as the projection eyepoint; and
displaying the new image,
wherein the new image shows a different view corresponding to the eyepoint movement of the viewer.

10. A method as in claim 9 wherein the horizontal perspective image is stereoscopic images.

11. A method as in claim 9 wherein the horizontal perspective image is calculated from a flat two dimensional picture.

12. A method as in claim 9 wherein the horizontal perspective image is calculated from a three dimensional model.

13. A method as in claim 9 wherein detecting a viewer eyepoint location is by manually inputting the location through a manual input device.

14. A method as in claim 13 wherein the manual input device is a computer peripheral or a wireless computer peripheral.

15. A method as in claim 13 wherein the manual input device is selected from a group consisted of a keyboard, a stylus, a keypad, a computer mouse, a computer trackball, a tablet, a pointing device.

16. A method as in claim 9 wherein the detection of a viewer eyepoint location is through an automatic input device whereby the automatic input device automatically extracts the eyepoint location from the viewer.

17. A method as in claim 16 wherein the automatic input device is selected from a group consisted of radio-frequency tracking device, infrared tracking device, camera tracking device.

18. A method as in claim 9 further comprising the step of manipulating the image.

19. A method as in claim 9 wherein the manipulation of the image comprises the modification of the displayed image or the generation of a new image.

20. A method as in claim 9 wherein the modification of the displayed image comprises the movement, zooming or rotation of the image.
